(19) United States
(12) Patent Application Publication
(10) Pub. No.: US 2022/0253052 A1
(43) Pub. Date: Aug. 11, 2022

(54) Anomaly Detection using Hybrid Autoencoder and Gaussian Process Regression

(71) Applicant: Landmark Graphics Corporation, Houston, TX (US)

(72) Inventors: Aditya Chemudupaty, Houston, TX (US); Srinath Madasu, Houston, TX (US); Shashi Dande, Houston, TX (US); Keshava Prasad Rangarajan, Houston, TX (US); Rohan Lewis, Houston, TX (US)

(73) Assignee: Landmark Graphics Corporation, Houston, TX (US)

(21) Appl. No.: 17/626,368

(22) PCT Filed: Jan. 16, 2020
(86) PCT No.: PCT/US2020/013849

§ 371 Date: Jan. 11, 2022

Related U.S. Application Data
(60) Provisional application No. 62/891,087, filed on Aug. 23, 2019.

(51) Int. Cl. G05B 23/02

(52) U.S. Cl. CPC G05B 23/0259

(57) ABSTRACT

A method for detecting anomalies in a piece of wellsite equipment. The method may include measuring data related to the piece of wellsite equipment. The method may also include encoding the measured data with a first autoencoder to produce a first set of encoded data. The method may further include performing a first Gaussian process regression (“GPR”) on the first set of encoded data to produce a first set of results that identifies a first anomaly in the measured data and that provides a first confidence interval for the first anomaly.

### BACKGROUND

This section is intended to provide relevant background information to facilitate a better understanding of the various aspects of the described embodiments. Accordingly, it should be understood that these statements are to be read in this light and not as admissions of prior art.

In oilfield operations, including drilling, completion, production, and other operations, equipment used to perform different functions may include sensors that measure parameters for determining the operability of a piece of equipment or optimize a process of the operation. One method of utilizing sensor data includes developing rule-based detection schemes that can be used to monitor performance of the equipment or parameters of a process. Based on the rules implemented within the detection schemes, the sensors, or a controller monitoring the sensors, can utilize a model to determine if the equipment is operating within acceptable parameters or if the process performance is being optimized based on detected conditions. However, sometimes an anomaly occurs between the detected conditions and the observed field conditions.

Existing systems primarily utilize only statistical models for anomaly detection using empirical methods without rigorous modeling. This approach may suffer issues however with respect to speed and accuracy of the anomaly detection as well as stability of the overall analysis process. Additionally, such systems may not have the flexibility to adapt to different oilfield operations. Further, existing models may not be capable of performing real time modeling of uncertainty and detecting simultaneously the anomaly.

### BRIEF DESCRIPTION OF THE DRAWINGS

The present disclosure is described with reference to the following figures. The same numbers are used throughout the figures to reference like features and components. The features depicted in the figures are not necessarily shown to scale. Certain features may be shown exaggerated in scale or in somewhat schematic form, and some details of elements may not be shown in the interest of clarity and conciseness.

FIG. 1 is a schematic diagram of a wellsite, according to one or more embodiments of the present disclosure;

FIG. 2 is a block diagram of a computer system, according to one or more embodiments; and

FIG. 3 is a flowchart of method for detecting anomalies in a data set.

### DETAILED DESCRIPTION

The present disclosure provides a method for anomaly detection using ML/Gaussian Process Regression (“GPR”). The method utilizes autoencoder and GPR for oilfield detective maintenance and production data use cases. The hybrid combination of autoencoder and GPR provides uncertainty and anomaly detection in real time, improving both speed and accuracy compared to existing systems.

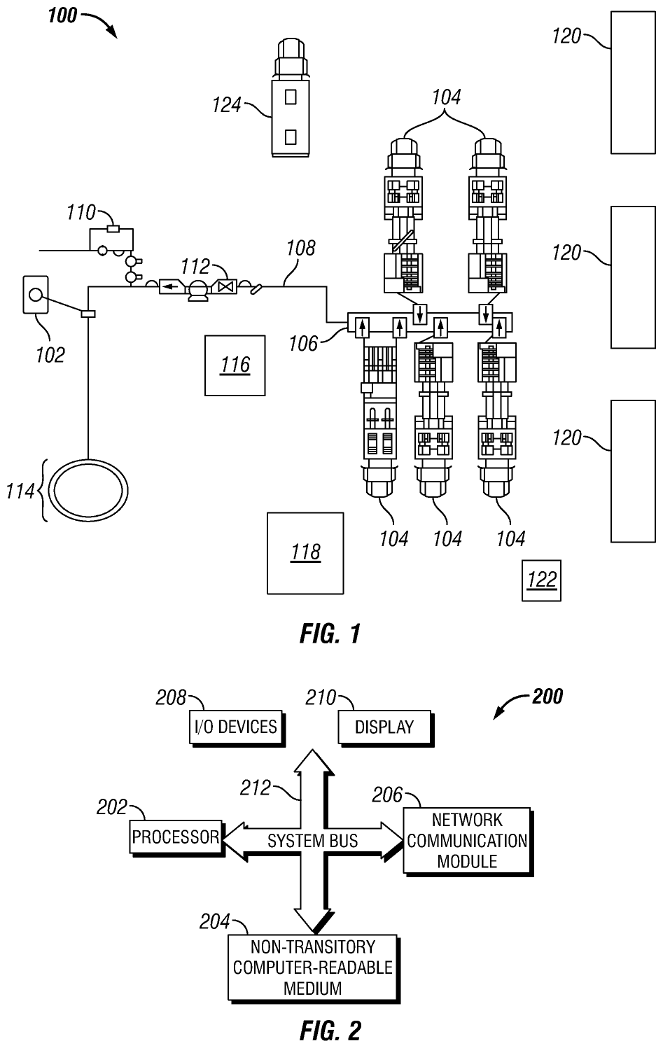

FIG. 1 is a schematic diagram of a wellsite 100, according to one or more embodiments of the present disclosure. The wellsite includes a wellhead 102 positioned over a wellbore (not shown) and connected to one or more pieces of wellsite equipment, such as, pumping systems 104. The pumping systems 104 are connected to a manifold 106 and piping 108. Further, the piping 108 may include additional equipment, such as, valves 110 and flowmeters 112. This additional equipment may be used, e.g., to monitor and/or control the flow of fluid into a wellbore through the wellhead 102.

The wellhead is also connected to a frac pond 114 having a liner that inhibits contact between the fluid within the frac pond 114 and the surrounding environment. After the pumping systems 104 pump fracturing fluid downhole through the wellhead 102, the fracturing fluid is circulated back uphole and deposited in the frac pond 114. The wellsite 100 may also include other pieces of equipment, such as, a generator 116, a blender 118, storage tanks 120 (three shown), a fluid distribution system 122, and a monitoring and control unit 124. The storage tanks 120 may contain fuel, wellbore fluids, proppants, diesel exhaust fluid, and/or other fluids.

Although not shown, the fluid distribution system 122 is fluidly coupled to one or more pieces of wellsite equipment, such as, the pumping systems 104, the generator 116, the blender 118, or the monitoring and control unit 124. The fluid distribution system 122 may supply fluids, such as, fuel, diesel exhaust fluid, fracturing fluid, and/or other fluids, to the pieces of wellsite equipment 104, 116, 118 from one or more of the storage tanks 120. In one or more embodiments, all or a portion of the aforementioned wellsite equipment may be mounted on trailers. However, the wellsite equipment may also be free standing or mounted on a skid.

Any of the above-mentioned pieces of equipment, including, but not limited to, the wellhead 102, the pumping systems 104, the manifold 106, the piping 108, the valves 110, the flowmeter 112, the frac pond 114, the generator 116, the blender 118, the storage tanks 120, and the fluid distribution system 122, may include one or more sensors that monitor, for example, the current condition of the equipment or flow of fluid through the equipment. The sensors may be used to take additional types measurements, as known by those skilled in the art. Further, one or more sensors may be located downhole and used to monitor conditions within the borehole. The sensors may be in electronic communication with the monitoring and control unit 124 through a wired and/or wireless connection.

Alternatively or in addition to the wired or wireless connection, a drone may be used to collect the data from one or more of the sensors and deliver the data to the monitoring and control unit 124. In such a scenario, a drone is moved into position proximate piece of equipment that data is being collected from. The data from the piece of equipment is then transferred to the drone via a wireless or wired connection. The drone is then retrieved and the data is offloaded onto a computer system within the monitoring and control unit 124.

As shown in FIG. 2, the monitoring and control unit 124 includes a computer system 200 that receives data from the sensor or sensors in the piece or pieces of equipment. As discussed above, the computer system 200 may receive data through a wired connection, a wireless connection, or via a drone. In at least one embodiment, one or more of the sensors also includes a separate computer system that is similar the computer system 200 of the monitoring and control unit 124 that receives data from the sensor.

The computer system 200 includes at least one processor 202, a non-transitory computer-readable medium 204, a network communication module 206, optional input/output devices 208, and an optional display 210 all interconnected via a system bus 212. Software instructions executable by the processor 202 for implementing software instructions stored within the computer system 200 in accordance with the illustrative embodiments described herein, are stored in the non-transitory computer-readable medium 204.

Although not explicitly shown in FIG. 2, it will be recognized that the computer system 200 may be connected to one or more public and/or private networks via appropriate network connections. It will also be recognized that software instructions may also be loaded into the non-transitory computer-readable medium 204 from a CD-ROM or other appropriate storage media via wired or wireless means.

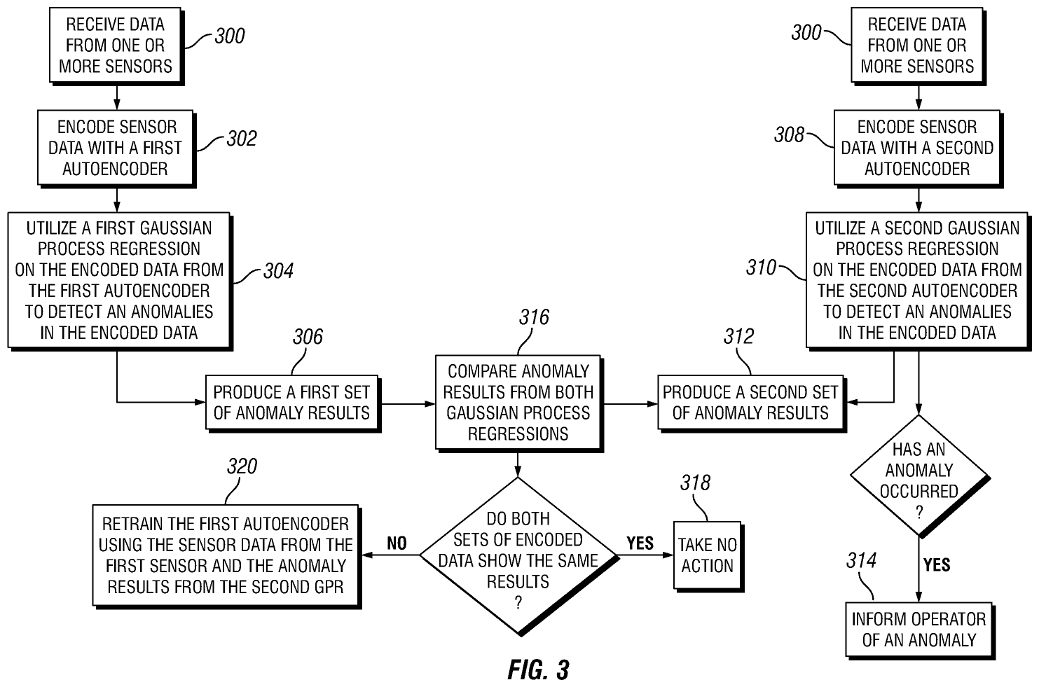

FIG. 3 is a flowchart of method for detecting anomalies in a data set of measurements from a sensor for a piece of wellsite equipment. The method may be performed by the sensor computer system and/or the monitoring and control unit 124 computer system 200. The illustrated method enables an operator to determine if an anomaly has occurred in the wellsite equipment in communication with the monitoring and control unit 124. Alternatively, the sensor computer system may perform portions of the method shown in FIG. 3, as noted below. Depending on the type, the location, and the intended use of the sensor, the anomaly may represent one of many different circumstances that can occur at the wellsite 100, such as, but not limited to, a change in production from the well, damage to a piece of wellsite equipment, or a blockage in a flowline.

In step 300, the computer system 200 receives data regarding a piece of wellsite equipment from a first sensor at the wellsite 100 through a wired connection, a wireless connection, or a drone. In embodiments in which the first sensor includes a sensor computer system, both the sensor computer system and the monitoring and control unit 124 computer system 200 receive the sensor data.

In step 302, the sensor data is encoded using a first autoencoder, a type of artificial neural network used to compress and encode data while removing noise from the data. The first autoencoder is trained using previous data from the first sensor that has been analyzed to identify any anomalies. This step can be performed by the sensor computer system and/or the monitoring and control unit 124 computer system 200, depending on the configuration of computer systems at the wellsite 100.

In step 304, the sensor computer system or the monitoring and control unit 124 computer system 200 performs a first Gaussian Process Regression (“GPR”) on the encoded data from the first autoencoder to detect if an anomaly has occurred. In step 306, a second set of anomaly results is produced based on the first GPR. The first GPR is performed using the radial basis function kernel, which distributes the encoded sensor data along a normal distribution and provides a confidence interval, the interval over which the sample data appears 95% of the time, for the normalized distribution. The first GPR is further trained for Boolean true-false detection of anomalies based on the normal distribution of previous data from the first sensor that has been analyzed to identify any anomalies and encoded by the first autoencoder. By performing a GPR on the encoded data from the first autoencoder, anomalies can be detected in real time, instead of identifying an anomaly when reviewing past sensor data.

In step 308, the data from the sensor is encoded by the monitoring and control unit 124 computer system 200 using a second autoencoder. In at least one embodiment, the sensor data is transmitted to the monitoring and control unit 124 in real time and the data is encoded by the second autoencoder in parallel with the data being encoded by the first autoencoder. The second autoencoder is trained using data from the first sensor, as well as many other sensors at the wellsite. Training the second autoencoder using the additional data from the other sensors allows the second autoencoder to provide more accurate detection of anomalies than the first autoencoder. However, the second autoencoder requires additional processing power and, therefore, is not utilized by the sensor computer system. Similar to the first autoencoder, the data used to train the second autoencoder has previously been analyzed to identify any anomalies.

In step 310, the monitoring and control unit 124 computer system 200 performs a second GPR on the encoded data from the second autoencoder to detect if an anomaly has occurred. In step 312, a second set of anomaly results is produced based on the second GPR. Similar to the first GPR, the second GPR is trained for Boolean true-false detection of anomalies based on the normal distribution of previous data from the first sensor and other wellsite sensors that has been analyzed to identify any anomalies and encoded by the second autoencoder.

If the second GPR detects that an anomaly has occurred in the sensor data, the monitoring and control unit 124 computer system 200 informs an operator, as shown in step 314. The monitoring and control unit 124 computer system 200 may alert an operator by displaying a message on a display in electronic connection with the monitoring and control unit 124 computer system 200. Alternatively or in addition to displaying a message, an anomaly indicator light may be illuminated, an electronic message, such as an email or a text message may be transmitted to the operator, and/or there may be an audible indication. The operator may also be informed of the anomaly through additional means known to those skilled in the art.

In step 316, the anomaly results from the first GPR based on the data encoded by the first autoencoder are compared with the anomaly results of the second GPR based on the data encoded by the second autoencoder. If the results are the same, i.e., both GPRs either show that an anomaly occurred or that no anomaly occurred, no action is taken, as shown in step 318. However, if the results of the GPRs are not the same, the first autoencoder is retrained using the sensor data from the first sensor and the anomaly results of the second GPR based on the data encoded by the second autoencoder, as shown in step 320. Retraining of the first autoencoder is done by either the monitoring and control unit 124 computer system 200 or on an offsite computer system. The retrained first autoencoder is then installed onto the monitoring and control unit 124 computer system 200 and/or the sensor computer system, depending on the configuration of computer systems at the wellsite 100, via a wired connection, a wireless connection, or a drone.

Once the first autoencoder has been retrained, the retrained first autoecoder is installed on the sensor computer system and/or the monitoring and control unit 124 computer system 200 to replace the previous version of the first autoencoder. The method shown in FIG. 3 is then repeated over time. Additionally, the anomalies identified by the second autoencoder are reviewed and it is determined if any of the wellsite equipment needs to be repaired or replaced.

Further examples include:

Example 1 is a method for detecting anomalies in a piece of wellsite equipment. The method includes measuring data related to the piece of wellsite equipment. The method also includes encoding the measured data with a first autoencoder to produce a first set of encoded data. The method further includes performing a first Gaussian process regression (“GPR”) on the first set of encoded data to produce a first set of results that identifies a first anomaly in the measured data and that provides a first confidence interval for the first anomaly.

In Example 2, the embodiments of any preceding paragraph or combination thereof further include encoding the measured data with a second autoencoder to produce a second set of encoded data. The method also includes performing a second GPR on the second set of encoded data to produce a second set of results that identifies a second anomaly in the measured data and that provides a second confidence interval for the second anomaly. The method further includes comparing the first set of results to the second set of results to determine if the first set of results is accurate.

In Example 3, the embodiments of any preceding paragraph or combination thereof further include retraining the first autoencoder using the measured data and the second set of results.

In Example 4, the embodiments of any preceding paragraph or combination thereof further include displaying the second set of results on a display.

In Example 5, the embodiments of any preceding paragraph or combination thereof further include wherein performing the first GPR comprises performing the first GPR in real time.

In Example 6, the embodiments of any preceding paragraph or combination thereof further include wherein performing the first GPR utilizes the radial basis function kernel.

In Example 7, the embodiments of any preceding paragraph or combination thereof further include training the first autoencoder with a set of data related to the piece of wellsite equipment that includes identified anomalies.

Example 8 is a system for detecting anomalies in a piece of wellsite equipment. The system includes a sensor operable to measure data related to the piece of wellsite equipment and a processor. The processor is programmed to encode the measured data with a first autoencoder to produce a first set of encoded data. The processor is further programmed to perform a first GPR on the first set of encoded data to produce a first set of results that identifies a first anomaly in the measured data and that provides a first confidence interval for the first anomaly.

In Example 9, the embodiments of any preceding paragraph or combination thereof further include wherein the processor is further programmed to encode the measured data with a second autoencoder to produce a second set of encoded data. The processor is also programmed to perform a second GPR on the second set of encoded to produce a second set of results that identifies a second anomaly in the measured data and that provides a second confidence interval for the second anomaly. The processor is further programmed to compare the first set of results to the second set of results to determine if the first set of results is accurate.

In Example 10, the embodiments of any preceding paragraph or combination thereof further include wherein the processor is further programmed to retrain the first autoencoder using the measured data and the second set of results.

In Example 11, the embodiments of any preceding paragraph or combination thereof further include a display in electronic communication with the processor, wherein the processor is further programmed to display the second set of results on the display.

In Example 12, the embodiments of any preceding paragraph or combination thereof further include wherein the first GPR is performed in real time.

In Example 12, the embodiments of any preceding paragraph or combination thereof further include wherein the processor is further programmed to train the first autoencoder with a set of data related to the piece of wellsite equipment that includes identified anomalies.

Example 14 is a non-transitory computer-readable medium comprising instructions which, when executed by a processor, enables the processor to perform a method for detecting anomalies in a piece of wellsite equipment. The method includes measuring data related to the piece of wellsite equipment. The method also includes encoding the measured data with a first autoencoder to produce a first set of encoded data. The method further includes performing a first GPR on the first set of encoded data to produce a first set of results that identifies a first anomaly in the measured data and that provides a first confidence interval for the first anomaly.

In Example 15, the embodiments of any preceding paragraph or combination thereof further include wherein the method further includes encoding the measured data with a second autoencoder to produce a second set of encoded data. The method also includes performing a second GPR on the second set of encoded data to produce a second set of results that identifies a second anomaly in the measured data and provides a second confidence interval for the second anomaly. The method further includes comparing the first set of results to the second set of results to determine if the first set of results is accurate.

In Example 16, the embodiments of any preceding paragraph or combination thereof further include wherein the method further comprises retraining the first autoencoder using the measured data and the second set of results.

In Example 17, the embodiments of any preceding paragraph or combination thereof further include wherein the method further comprises displaying the second set of results on a display.

In Example 18, the embodiments of any preceding paragraph or combination thereof further include wherein performing the first GPR comprises performing the first GPR in real time.

In Example 19, the embodiments of any preceding paragraph or combination thereof further include wherein performing the first GPR utilizes the radial basis function kernel.

In Example 20, the embodiments of any preceding paragraph or combination thereof further include wherein the method further comprises training the first autoencoder with a set of data related to the piece of wellsite equipment that includes identified anomalies.

For the embodiments and examples above, a non-transitory computer-readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various embodiments of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of the anomalies. Such a user interface can be operated in conjunction with the communications unit and the bus. Various components of the system can be integrated such that processing identical to or similar to the processing schemes discussed with respect to various embodiments herein can be performed.

In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A method for detecting anomalies in a piece of wellsite equipment, the method comprising:
measuring data related to the piece of wellsite equipment;
encoding the measured data with a first autoencoder to produce a first set of encoded data; and
performing a first Gaussian process regression (“GPR”) on the first set of encoded data to produce a first set of results that identifies a first anomaly in the measured data and that provides a first confidence interval for the first anomaly.

2. The method of claim 1, further comprising:
encoding the measured data with a second autoencoder to produce a second set of encoded data;
performing a second GPR on the second set of encoded data to produce a second set of results that identifies a second anomaly in the measured data and that provides a second confidence interval for the second anomaly; and
comparing the first set of results to the second set of results to determine if the first set of results is accurate.

3. The method of claim 2, further comprising retraining the first autoencoder using the measured data and the second set of results.

4. The method of claim 2, further comprising displaying the second set of results on a display.

5. The method of claim 1, wherein performing the first GPR comprises performing the first GPR in real time.

6. The method of claim 1, wherein performing the first GPR utilizes the radial basis function kernel.

7. The method of claim 1, further comprising training the first autoencoder with a set of data related to the piece of wellsite equipment that includes identified anomalies.

8. A system for detecting anomalies in a piece of wellsite equipment, the system comprising:
a sensor operable to measure data related to the piece of wellsite equipment; and
a processor programmed to:
encode the measured data with a first autoencoder to produce a first set of encoded data; and
perform a first GPR on the first set of encoded data to produce a first set of results that identifies a first anomaly in the measured data and that provides a first confidence interval for the first anomaly.

9. The system of claim 8, wherein the processor is further programmed to:
encode the measured data with a second autoencoder to produce a second set of encoded data;
perform a second GPR on the second set of encoded to produce a second set of results that identifies a second anomaly in the measured data and that provides a second confidence interval for the second anomaly; and
compare the first set of results to the second set of results to determine if the first set of results is accurate.

10. The system of claim 9, wherein the processor is further programmed to retrain the first autoencoder using the measured data and the second set of results.

11. The system of claim 9, further comprising a display in electronic communication with the processor, wherein the processor is further programmed to display the second set of results on the display.

12. The system of claim 8, wherein the first GPR is performed in real time.

13. The system of claim 8, wherein the processor is further programmed to train the first autoencoder with a set of data related to the piece of wellsite equipment that includes identified anomalies.

14. A non-transitory computer-readable medium comprising instructions which, when executed by a processor, enables the processor to perform a method for detecting anomalies in a piece of wellsite equipment, the method comprising:
measuring data related to the piece of wellsite equipment;
encoding the measured data with a first autoencoder to produce a first set of encoded data; and
performing a first GPR on the first set of encoded data to produce a first set of results that identifies a first anomaly in the measured data and that provides a first confidence interval for the first anomaly.

15. The non-transitory computer-readable medium of claim 14, wherein the method further comprises:
encoding the measured data with a second autoencoder to produce a second set of encoded data;
performing a second GPR on the second set of encoded data to produce a second set of results that identifies a second anomaly in the measured data and provides a second confidence interval for the second anomaly; and
comparing the first set of results to the second set of results to determine if the first set of results is accurate.

16. The non-transitory computer-readable medium of claim 15, wherein the method further comprises retraining the first autoencoder using the measured data and the second set of results.

17. The non-transitory computer-readable medium of claim 15, wherein the method further comprises displaying the second set of results on a display.

18. The non-transitory computer-readable medium of claim 14, wherein performing the first GPR comprises performing the first GPR in real time.

19. The non-transitory computer-readable medium of claim 14, wherein performing the first GPR utilizes the radial basis function kernel.

20. The non-transitory computer-readable medium of claim 14, wherein the method further comprises training the first autoencoder with a set of data related to the piece of wellsite equipment that includes identified anomalies.
